(19) United States
(12) Patent Application Publication
(10) Pub. No.: US 2026/0086002 A1
(43) Pub. Date: Mar. 26, 2026

(54) FLOW CHANNEL INSTALLATION MECHANISM AND FLOW CHANNEL SYSTEM

(71) Applicant: FlowVIEW Tek, Taipei City (TW)

(72) Inventors: Jui Feng Cheng, Taipei City (TW); Yu Kai Lin, Taipei City (TW); Cheng Che Lee, Taipei City (TW); Min-Chuan Shih, Taipei City (TW); Kuo Chao Feng, Taipei City (TW)

(73) Assignee: FlowVIEW Tek, Taipei City (TW)

(21) Appl. No.: 19/243,624

(22) Filed: Jun. 19, 2025

Related U.S. Application Data
(60) Provisional application No. 63/699,176, filed on Sep. 26, 2024.

(51) Int. Cl. G01N 1/20; G01N 15/0227

(52) U.S. Cl. CPC G01N 1/2035; G01N 15/0227; G01N 2001/205

(57) ABSTRACT

A flow channel installation mechanism includes a guiding assembly and a watertight jointing device. The guiding assembly is configured to guide a detected block into the guiding assembly. The guiding assembly includes a leaning body, a supporting body, and a roller set. The leaning body has a chamfer. The roller set is connected to the supporting body via at least one first elastic element, wherein the detected block is adapted to be inserted between the leaning body and the roller set. The watertight jointing device is connected to a force exerting body via at least one second elastic element and has at least two openings. The force exerting body is configured to move towards the leaning body to exert a pressure on the detected block. The leaning body, the supporting body, and the force exerting body are arranged on a light channel. A flow channel system is also provided.

### CROSS-REFERENCE TO RELATED APPLICATION

This application claims the priority benefit of U.S. provisional application Ser. No. 63/699,176, filed on Sep. 26, 2024. The entirety of the above-mentioned patent application is hereby incorporated by reference herein and made a part of this specification.

### BACKGROUND

### Technical Field

The invention relates to a flow channel installation mechanism and a flow channel system.

### Description of Related Art

Requirements for application of fluid sample inspection take place in various fields, such as the biomedical and pharmaceutical industry, the semiconductor industry, the environmental engineering industry, and the like. Fluid image detectors may be used to observe and photograph the information of samples flowing in a flow channel. However, in current fluid image detectors, flow channels are difficult to install quickly and securely without damage.

### SUMMARY

Accordingly, the invention is directed to a flow channel installation mechanism, which can be installed quickly and securely without damage.

The invention is directed to a flow channel system, which can be quickly disassembled for cleaning or replacement.

An embodiment of the invention provides a flow channel installation mechanism including a guiding assembly and a watertight jointing device. The guiding assembly is configured to guide a detected block into the guiding assembly. The guiding assembly includes a leaning body, a supporting body, and a roller set. The leaning body has a chamfer. The roller set is connected to the supporting body via at least one first elastic element, wherein the detected block is adapted to be inserted between the leaning body and the roller set. The watertight jointing device is connected to a force exerting body via at least one second elastic element and has at least two openings, wherein the force exerting body is configured to move towards the leaning body so as to exert a pressure on the detected block. The leaning body, the supporting body, and the force exerting body are arranged on a light channel, and structures of the leaning body, the supporting body, and the force exerting body are hollowed out or dodged to allow light to pass through unimpeded.

An embodiment of the invention provides a flow channel system including a transparent flow channel device, a particle size screening device, a tapered container, a three-way pipeline switching valve, a pump, and an air particle filter. The particle size screening device is disposed upstream of the transparent flow channel device. The tapered container is disposed upstream of the transparent flow channel device. The three-way pipeline switching valve is disposed downstream of the transparent flow channel device. The pump is disposed downstream of the three-way pipeline switching valve and configured to pump fluid. The air particle filter is connected with the tapered container.

In the flow channel installation mechanism according to the embodiment of the invention, the guiding assembly is adopted, so that the detected block can be installed quickly. In addition, since the leaning body has a chamfer, and the guiding assembly has roller set, the detected block will not be scratched. Since the leaning body presses the detected block, and since the detected block and the watertight jointing device are physically pressed together, the flow channel installation mechanism can be installed securely. In addition, the flow channel system according to the embodiment of the invention can be quickly disassembled for cleaning or replacement, and has a particle size screening design without significant pressure drop. Moreover, in the flow channel system according to the embodiment of the invention, the pump extracting and draining the sample and the air particle filter are adopted, so that the pollution of the flow channel system itself or the environment can be avoided.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic view of a flow channel installation mechanism according to an embodiment of the invention.

FIG. 2 is a schematic view of a flow channel system according to an embodiment of the invention.

FIG. 3 is a schematic view showing the details of the particle size screening device in FIG. 2.

### DESCRIPTION OF THE EMBODIMENTS

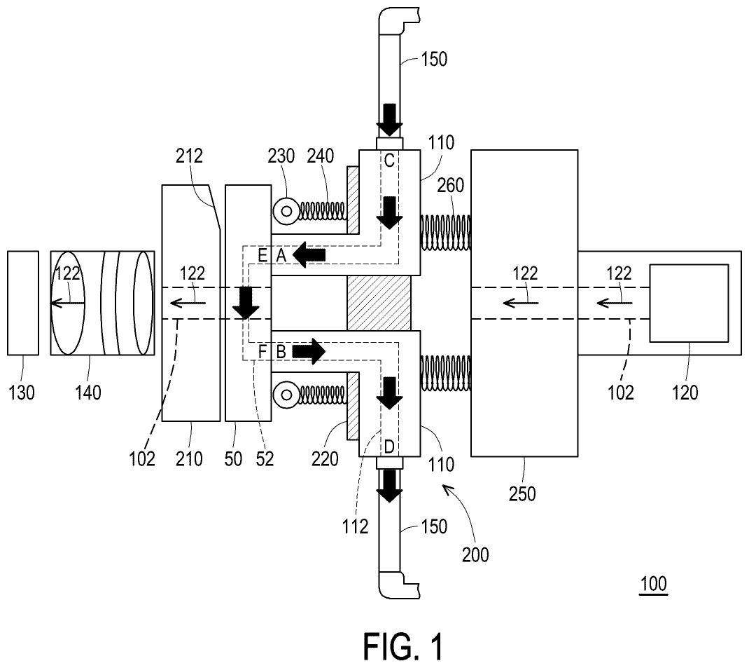

FIG. 1 is a schematic view of a flow channel installation mechanism according to an embodiment of the invention. Referring to FIG. 1, the flow channel installation mechanism 100 in this embodiment includes a guiding assembly 200 and a watertight jointing device 110. The guiding assembly 200 is configured to guide a detected block 50 into the guiding assembly 200. The guiding assembly 200 includes a leaning body 210, a supporting body 220, and a roller set 230. The leaning body 210 has a chamfer 212. The roller set 230 is connected to the supporting body 220 via at least one first elastic element 240, wherein the detected block 50 is adapted to be inserted between the leaning body 210 and the roller set 230.

The watertight jointing device 110 is connected to a force exerting body 250 via at least one second elastic element 260 and has at least two openings A and B, wherein the force exerting body 250 is configured to move towards the leaning body 210 so as to exert a pressure on the detected block 50. In this embodiment, each of the first elastic element 240 and the second elastic element 260 is, for example, a spring. The leaning body 210, the supporting body 220, and the force exerting body 250 are arranged on a light channel 102, and structures of the leaning body 210, the supporting body 220, and the force exerting body 250 are hollowed out or dodged to allow light (e.g. a light beam 122) to pass through unimpeded.

In this embodiment, the detected block 50 is a transparent body and has a first flow channel 52 therein. The first flow channel 52 has two openings E and F at a same side of the detected block 50, and the two openings E and F of the first flow channel 52 are configured to be connected with the two openings A and B of the watertight jointing device 110.

In this embodiment, the flow channel installation mechanism 100 further includes a light source 120, an image sensor 130, and a lens assembly 140. The light source 120 is configured to provide a light beam 122, wherein the detected block 50 is disposed on a path of the light beam 122. The image sensor 130 is disposed on the path of the light beam 122 from the detected block 50. The lens assembly 140 is disposed on the path of the light beam 122 between the detected block 50 and the image sensor 130.

In this embodiment, the watertight jointing device 110 has at least four openings A, B, C, and D, two openings A and B of the at least four openings A, B, C, and D are connected to the detected block 50, other two openings C and D of the at least four openings A, B, C, and D are connected to fluid pipes 150, and the watertight jointing device 110 has a second flow channel 112 to communicate with the detected block 50 and the fluid pipes 150. In this embodiment, the first flow channel 52 and the second flow channel 112 are, for example, micro flow channels.

In the flow channel installation mechanism 100 in this embodiment, the guiding assembly 200 is adopted, so that the detected block 50 including a micro flow channel can be installed quickly. In addition, since the leaning body 210 has a chamfer 212, and the guiding assembly 200 has roller set 230, the detected block 50 will not be scratched. Since the leaning body 210 presses the detected block 50, and since the openings E and F of the detected block 50 and the openings A and B of the watertight jointing device 110 are physically pressed together, respectively, the micro flow channel of the detected block 50 is watertight and resistant to liquid pressure. In terms of hardware structure and linkage, the watertight jointing device 110 and the supporting body 220 are independent of each other; that is, the watertight jointing device 110 and the supporting body 220 can move independently of each other. The supporting body 220 provides a convenient guide for the detected block 50 so that it can reach the correct position, and the supporting body 220 provides support for the detected block 50 so that it does not loosen. The watertight jointing device 110 is connected to the detected block 50, so that the first flow channel 52 and the second flow channel 112 are connected, and in this embodiment, the watertight jointing device 110 applies a greater pressure to the detected block 50 than the supporting body 220 does, so as to prevent liquid leakage at the connection points.

Moreover, structures of the leaning body 210, the supporting body 220, and the force exerting body 250 are hollowed out or dodged to allow light (e.g. a light beam 122) to pass through unimpeded, so that the image sensor 130 can obtain the image of the first flow channel 52 in the detected block 50.

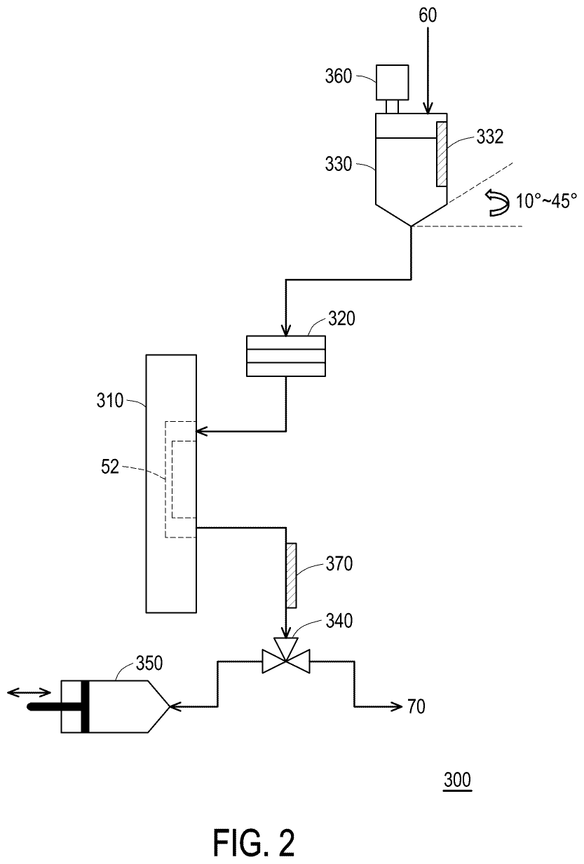

FIG. 2 is a schematic view of a flow channel system according to an embodiment of the invention. Referring to FIG. 2, the flow channel system 300 in this embodiment includes a transparent flow channel device 310, a particle size screening device 320, a tapered container 330, a three-way pipeline switching valve 340, a pump 350, and an air particle filter 360. The particle size screening device 320 is disposed upstream of the transparent flow channel device 310. The tapered container 330 is disposed upstream of the transparent flow channel device 310. In this embodiment, the tapered container 330 is disposed upstream of the particle size screening device 320. The three-way pipeline switching valve 340 is disposed downstream of the transparent flow channel device 310. The pump 350 is disposed downstream of the three-way pipeline switching valve 340 and configured to pump fluid. The air particle filter 360 is connected with the tapered container 330.

In this embodiment, the tapered container 330 includes a liquid level detector 332. Besides, the flow channel system 300 further includes a liquid fill detector 370 disposed downstream of the transparent flow channel device 310. A sample may flow through a liquid entrance 60, the tapered container 330, the particle size screening device 320, the transparent flow channel device 310, and the liquid fill detector 370 in sequence. In this embodiment, the tapered container 330 has a tapered bottom, so as to ensure that settled particles in the sample can also be detected. In an embodiment, the tapered bottom has an inclined angle of 10 degrees to 45 degrees with respect to a horizontal plane, as shown in FIG. 2, but the invention is not limited thereto. In this embodiment, the transparent flow channel device 310 may be the detected block 50 in FIG. 1. Moreover, the liquid fill detector 370 can ensure that the first flow channel 52 (e.g. a micro flow channel) is filled with the sample without being affected by bubbles.

The structure of FIG. 1 and the structure of FIG. 2 can be combined. For example, the particle size screening device 320 in FIG. 2 may be disposed upstream of the watertight jointing device 110 via the fluid pipe 150 at the top of FIG. 1, and the liquid fill detector 370 in FIG. 2 may be disposed downstream of the watertight jointing device 110 via the fluid pipe 150 at the bottom of FIG. 1. Moreover, when the image sensor 130 detects the image of the first flow channel 52, the pump 350 extracts the sample from the liquid fill detector 370, and the three-way pipeline switching valve 340 is configured to prevent the sample from flowing out of the liquid exit 70. After the image sensor 130 detects the image of the first flow channel 52, the pump 350 drains the sample out of the liquid exit, and the three-way pipeline switching valve 340 is configured to prevent the sample from flowing upwards to the liquid fill detector 370.

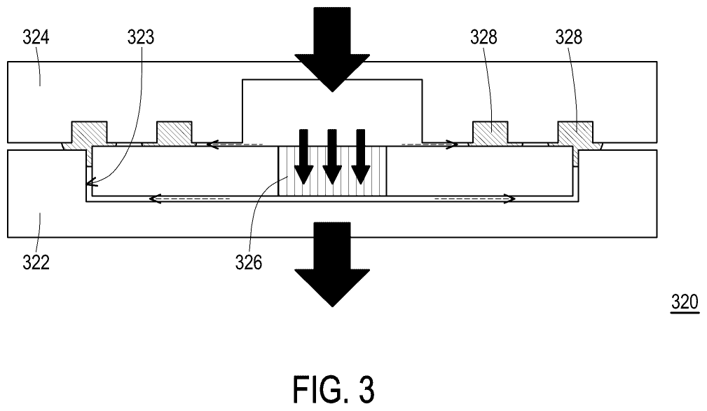

FIG. 3 is a schematic view showing the details of the particle size screening device in FIG. 2. Referring to FIG. 2 and FIG. 3, the particle size screening device 320 in this embodiment includes a fixture 322, a cover 324, a sieve 326, and at least one waterproof ring 328 (two waterproof rings 328 are exemplarily shown in FIG. 3). The fixture 322 has a containing recess 323. The cover 324 is disposed on the fixture 322. The sieve 326 is disposed in the containing recess 323 and between the fixture 322 and the cover 324. The waterproof rings 328 are disposed between the fixture 322 and the cover 324.

The flow channel system 300 in this embodiment can be quickly disassembled for cleaning or replacement, and has a particle size screening design without significant pressure drop. Moreover, in the flow channel system 300 in this embodiment, the pump 350 extracting and draining the sample and the air particle filter 360 are adopted, so that the pollution of the flow channel system 300 itself or the environment can be avoided. Besides, in the flow channel system 300 in this embodiment, the three-way pipeline switching valve 340 is adopted, the pump 350 extracts the sample from the liquid fill detector 370 when the three-way pipeline switching valve 340 is configured to prevent the sample from flowing out of the liquid exit, and the pump 350 drains the sample out of the liquid exit when three-way pipeline switching valve 340 is configured to prevent the sample from flowing upwards to the liquid fill detector 370, which can avoid gas generated in the pipeline which switching the valve to update the sample, wherein generated gas may affect detection. In addition, in the flow channel system 300 in this embodiment, the tapered container 330 has a tapered bottom, which can prevent particles in the sample to be measured from settling and failing to be transported into the detected region, i.e. the first flow channel 52.

In conclusion, in the flow channel installation mechanism according to the embodiment of the invention, the guiding assembly is adopted, so that the detected block can be installed quickly. In addition, since the leaning body has a chamfer, and the guiding assembly has roller set, the detected block will not be scratched. Since the leaning body presses the detected block, and since the detected block and the watertight jointing device are physically pressed together, the flow channel installation mechanism can be installed securely. In addition, the flow channel system according to the embodiment of the invention can be quickly disassembled for cleaning or replacement, and has a particle size screening design without significant pressure drop. Moreover, in the flow channel system according to the embodiment of the invention, the pump extracting and draining the sample and the air particle filter are adopted, so that the pollution of the flow channel system itself or the environment can be avoided.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A flow channel installation mechanism comprising:
a guiding assembly configured to guide a detected block into the guiding assembly, the guiding assembly comprising:
a leaning body having a chamfer;
a supporting body; and
a roller set connected to the supporting body via at least one first elastic element, wherein the detected block is adapted to be inserted between the leaning body and the roller set; and
a watertight jointing device connected to a force exerting body via at least one second elastic element and having at least two openings, wherein the force exerting body is configured to move towards the leaning body so as to exert a pressure on the detected block,
wherein the leaning body, the supporting body, and the force exerting body are arranged on a light channel, and structures of the leaning body, the supporting body, and the force exerting body are hollowed out or dodged to allow light to pass through unimpeded.

2. The flow channel installation mechanism according to claim 1, wherein the detected block is a transparent body and has a first flow channel therein, the first flow channel has two openings at a same side of the detected block, and the two openings of the first flow channel are configured to be connected with the two openings of the watertight jointing device.

3. The flow channel installation mechanism according to claim 2 further comprising:
a light source configured to provide a light beam, wherein the detected block is disposed on a path of the light beam;
an image sensor disposed on the path of the light beam from the detected block; and
a lens assembly disposed on the path of the light beam between the detected block and the image sensor.

4. The flow channel installation mechanism according to claim 2, wherein the watertight jointing device has at least four openings, two openings of the at least four openings are connected to the detected block, other two openings of the at least four openings are connected to fluid pipes, and the watertight jointing device has a second flow channel to communicate with the detected block and the fluid pipes.

5. A flow channel system comprising:
a transparent flow channel device;
a particle size screening device disposed upstream of the transparent flow channel device;
a tapered container disposed upstream of the transparent flow channel device;
a three-way pipeline switching valve disposed downstream of the transparent flow channel device;
a pump disposed downstream of the three-way pipeline switching valve and configured to pump fluid; and
an air particle filter connected with the tapered container.

6. The flow channel system according to claim 5, wherein the tapered container includes a liquid level detector.

7. The flow channel system according to claim 5 further comprising a liquid fill detector disposed downstream of the transparent flow channel device.

8. The flow channel system according to claim 5, wherein the particle size screening device comprises:
a fixture having a containing recess;
a cover disposed on the fixture;
a sieve disposed in the containing recess and between the fixture and the cover; and
at least one waterproof ring disposed between the fixture and the cover.
